(19) United States
(12) Patent Application Publication
(10) Pub. No.: US 2010/0092741 A1
(43) Pub. Date: Apr. 15, 2010

(54) MICROPARTS AND APPARATUS FOR SELF-ASSEMBLY AND ALIGNMENT OF MICROPARTS THEREOF

(75) Inventors: FAN GANG TSENG, HSINCHU CITY (TW); CHENG LIN, HSINCHU CITY (TW); CHING CHANG CHIENG, HSINCHU CITY (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL TSING HUA UNIVERSITY, HSINCHU (TW)

(21) Appl. No.: 12/552,349

(22) Filed: Sep. 2, 2009

(30) Foreign Application Priority Data
Oct. 9, 2008 (TW) 097138823

(51) Int. Cl. B32B 3/00

(52) U.S. Cl. 428/209; 428/195.1; 428/210

(57) ABSTRACT

A first hydrophilic area, a second hydrophilic area, and a hydrophobic area are provided on one surface of a micropart. The first hydrophilic area surrounds the hydrophobic area, and the hydrophobic area surrounds the second hydrophilic area. The pattern of the hydrophobic area has at most a symmetrical line.

### BACKGROUND OF THE INVENTION

(A) Field of the Invention

The present invention relates to microparts and an apparatus for self-assembly and alignment of microparts, and more particularly, to an apparatus utilizing fluidic self-assembly technology to implement the orientation combination of a large number of microparts.

(B) Description of the Related Art

As the size of a device is gradually decreased, the scaling law governs the behavior of the device and major action forces such as the gravitational force become less important. Instead, surface tension force become more significant forces.

Radio frequency identification (RFID) tags and light emitting diodes (LEDs) are current common examples of products utilizing microparts. The feature of such products is to employ a large number of dies which are microparts of micro dimension. Therefore, many assembly technologies have been proposed for implementing the package process of such microparts and effectively mounting a large number of microparts in certain orientations.

There are two kinds of well-known conventional package technologies for a large number of microparts. The first is the FSA (fluidic self-assembly) technology. FIG. 1 is a schematic diagram illustrating fluidic self-assembly. This technology forms a plurality of array-arranged notches 13 corresponding to the profiles of the bottoms of microparts on a silicon substrate 11 by etching. The substrate 11 is immersed in a solvent 14, and the microparts 12 are caused to move by the flow of the solvent 14. Because the substrate 11 has the notches 13 corresponding to the profiles of the microparts 12, the microparts 12 are dropped into the notches 13 to achieve the orientation objective. Furthermore, an oriented bump is formed on the bottom of each micropart 12, including for example a trapezoid bump or a semicircle bump. The profile of the corresponding notch 13 is complementary to that of the bump so that the orientation or direction objective is achieved. U.S. Pat. Nos. 6,657,289 and 7,223,635 utilize such a technology to package large quantities of microparts. However, such a technology requires forming the bottom of the microparts 12 as a specified profile and providing a quantity of microparts 12 greater than the practically assembled number so as to increase the possibility of microparts dropping into the notches.

Unlike the fluidic self-assembly technology utilizing objects with complementary profiles to combine with each other as shown in FIG. 1, the second method utilizes a modified surface to improve the contact between two surfaces and increase the possibility of orientation. This technology deposits a metal layer of Ni/Au on the bottoms of microparts, and overlays a alkanethiol(CH₃—SH) self-assembly monolayer (SAM) of hydrophobic on the metal layer. Furthermore, a plurality of Au pads are disposed at certain locations on a substrate designed to bond the microparts, and a hydrophobic alkanethiol SAM is overlaid on the Au pads. Next, hydrocarbon glue is coated on the Au pads. During the assembly process, the substrate is immersed in water. The microparts sequentially dropped in the water can self-locate on the Au pads with modified surfaces through capillary force. If the hydrophobic films on the Au pads of the substrate and the bottoms of the microparts are rectangular, there are two conditions to their correct orientation. That is, only one directional orientation is impossible.

FIG. 2 is a graph showing a relationship between the rotating angle and the overlapping area when all of the Au pads of the substrate and the hydrophobic film on the bottoms of the microparts are rectangular and automatically align with each other. The rectangle shown in FIG. 2 has a length-to-width ratio of 2:1. When the relative angle of the Au pad of the substrate and the hydrophobic film on the bottom of the micropart is between 90 and 270 degrees upon their initial contact, the micropart automatically rotates towards the angle of 180 degrees relative to the Au pad. Finally, the micropart stops at the predetermined angle. That is, two rectangles completely overlap each other. However, there is an orientation difference of 180 degrees between the Au pad of the substrate and the micropart.

The second method utilizes a high-speed picking and placing apparatus to achieve the placement of the microparts. The method uses a mechanical arm to pick, transfer and place the microparts. After the microparts are picked, they are transferred to a designated mounting position on the substrate. Such a method has the following disadvantages: (1) the picking and place apparatus needs a complicated position sensing device, a signal processing device and a position adjustment device; (2) much time is needed to complete placement of microparts; (3) only one micropart is picked with each stroke so the quantity of processed units per hour is quite low; and (4) it is difficult to handle microparts of sub-millimeter scale.

In view of above, there is an urgent need for an apparatus to speedily and accurately achieve the orientation combination of a large number of microparts. Such an apparatus would allow dies of micro scale to be packaged by mass production process so as to reduce the cost of the package of the microparts.

### SUMMARY OF THE INVENTION

The present invention provides microparts and an apparatus for self-assembly and alignment of microparts to implement the orientation combination of a large number of microparts. It utilizes hydrophobic regions with specified patterns to enable the microparts to automatically adjust themselves within a short period of time. The potential well between two contact regions is minimized during the adjusting movement so that the objective of self-assembly for high-speed alignment is achieved.

The present invention provides a micropart. A first hydrophilic area, a second hydrophilic area, and a hydrophobic area are provided on one surface of the micropart. The first hydrophilic area surrounds the hydrophobic area, and the hydrophobic area surrounds the second hydrophilic area. The pattern of the hydrophobic area has at most a symmetrical line.

The present invention provides an apparatus for self-assembly and alignment of microparts with which at least one micropart can be aligned and combined. A first hydrophilic area, a second hydrophilic area, and a hydrophobic area are provided on one surface of the self-assembly and alignment apparatus. The first hydrophilic area surrounds the hydrophobic area, and the hydrophobic area surrounds the second hydrophilic area. The pattern of the hydrophobic area has at most a symmetrical line.

### BRIEF DESCRIPTION OF THE DRAWINGS

The objectives and advantages of the present invention will become apparent upon reading the following description and upon reference to the accompanying drawings in which:

FIG. 1 is a schematic diagram of conventional fluidic self-assembly method;

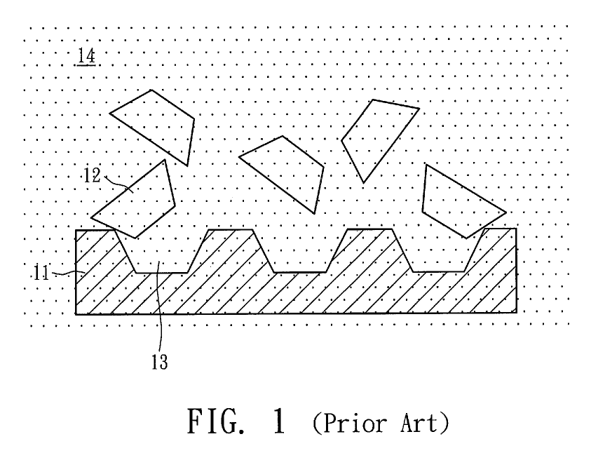

FIG. 2 is a graph showing a relationship between the rotating angle and the overlapping area when all of the Au pads of the substrate and the hydrophobic film on the bottoms of the microparts are rectangular and automatically aligning with each other;

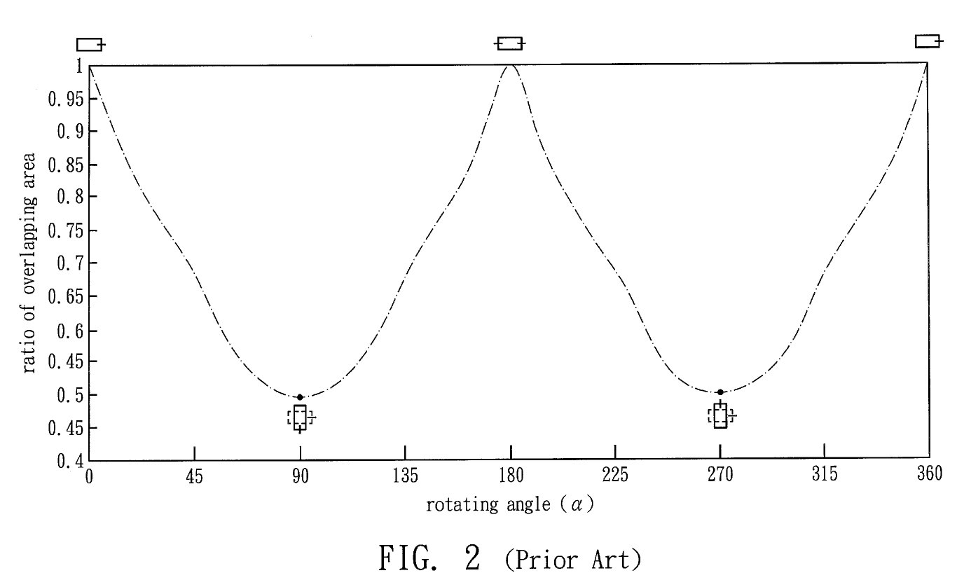

FIGS. 3A-3C are schematic diagrams of the patterned surfaces of microparts in accordance with the present invention;

FIGS. 4A-4B are cross-sectional diagrams of the microparts in accordance with the present invention;

FIG. 5 is a top view of an apparatus for self-assembly and alignment of microparts in accordance with the present invention;

FIG. 6 shows a relationship between the rotating angle and the overlapping area when all of the microparts in FIGS. 3A-3C and the hydrophobic region patterns on a substrate automatically align with each other; and

FIGS. 7A-7G are pictures of a micropart 33 and the hydrophobic region patterns on a substrate during the rotating motion of automatic alignment.

### DETAILED DESCRIPTION OF THE INVENTION

The following will demonstrate the present invention using the accompanying drawings to clearly present the characteristics of the technology.

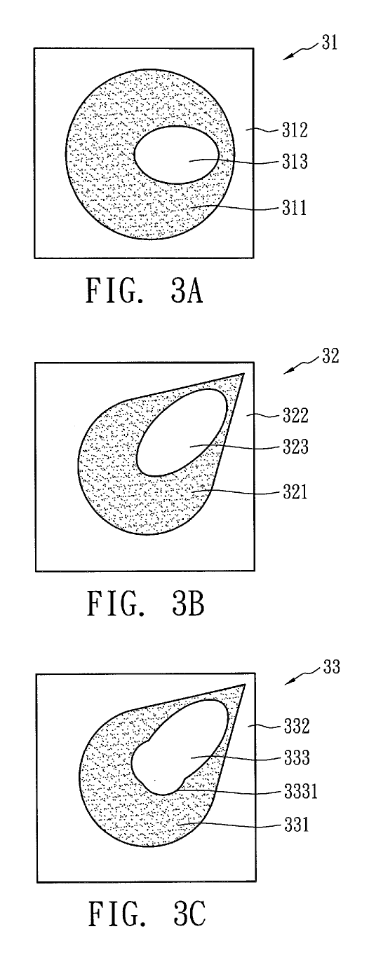

FIGS. 3A-3C are schematic diagrams of the patterned surfaces of microparts in accordance with the present invention. As shown in FIG. 3A, a first hydrophilic area 312, a second hydrophilic area 313, and a hydrophobic area 311 are on the passive surface of the micropart 31. The first hydrophilic area 312 surrounds the hydrophobic area 311, and the hydrophobic area 311 surrounds the second hydrophilic area 313. When the micropart 31 is made of a silicon wafer, the first hydrophilic area 312 and the second hydrophilic area 313 can be the surface of a silica layer. The hydrophobic area 311 with a circular profile is overlaid with gold. The second hydrophilic area 313 is elliptical, and is near the border of the hydrophobic area 311 instead of at the center of the hydrophobic area 311. A Ni layer or Ti layer can be further interposed between the gold layer and the silica layer so as to improve the combination of the gold layer and the silica layer. The pattern of the hydrophobic area 311 has at most one symmetrical line. That is, the ring-shaped hydrophobic area 311 in FIG. 3A has only one horizontal symmetrical line. There are no other symmetrical lines along any direction. The long axis of the elliptical second hydrophilic area 313 is overlapped with the horizontal symmetrical line of the ring-shaped hydrophobic area 311.

As shown in FIG. 3B, a first hydrophilic area 322, a second hydrophilic area 323, and a hydrophobic area 321 are on the passive surface of the micropart 32. The first hydrophilic area 322 surrounds the hydrophobic area 321, and the hydrophobic area 321 surrounds the second hydrophilic area 323. When the micropart 32 is made of a silicon wafer, the first hydrophilic area 322 and the second hydrophilic area 323 can be the surface of a silica layer. The hydrophobic area 321 with a teardrop-shaped profile is overlaid with gold. The second hydrophilic area 323 is elliptical, and is near the tip of the hydrophobic area 321. A Ni layer or Ti layer can be further interposed between the gold layer and the silica layer so as to improve the combination of the gold layer and the silica layer. The pattern of the hydrophobic area 321 has at most one symmetrical line. That is, the ring-shaped hydrophobic area 321 in FIG. 3B has only one horizontal symmetrical line. There are no other symmetrical lines along any direction. The long axis of the elliptical second hydrophilic area 323 is overlapped with the horizontal symmetrical line of the teardrop-shaped and ring-shaped hydrophobic area 321.

As shown in FIG. 3C, a first hydrophilic area 332, a second hydrophilic area 333, and a hydrophobic area 331 are on the passive surface of the micropart 33. The first hydrophilic area 332 surrounds the hydrophobic area 331, and the hydrophobic area 331 surrounds the second hydrophilic area 333. When the micropart 33 is made of a silicon wafer, the first hydrophilic area 332 and the second hydrophilic area 333 can be the surface of a silica layer. The hydrophobic area 331 with a teardrop-shaped profile is overlaid with gold. In comparison with the second hydrophilic area 323 of FIG. 3B, the second hydrophilic area 333 looks like a partially modified ellipse. That is, the partial curve of the ellipse at one end of its long axis is replaced by two arcs 3331 connected to each other, and is near the tip of the hydrophobic area 331. A Ni layer or Ti layer can be further interposed between the gold layer and the silica layer so as to improve the combination of the gold layer and the silica layer. The pattern of the hydrophobic area 331 has at most one symmetrical line. That is, the ring-shaped hydrophobic area 331 in FIG. 3C has only one horizontal symmetrical line. There are no other symmetrical lines along any direction. The long axis of the second hydrophilic area 333 with a partially modified elliptical shape is overlapped with the horizontal symmetrical line of the teardrop-shaped and ring-shaped hydrophobic area 331.

The patterns of the hydrophobic area and the hydrophilic area shown in FIGS. 3A-3C have excellent self-alignment capability. The distance between the geometric centers of the second hydrophilic area and the hydrophobic area is given as d, and the equivalent diameter of the second hydrophilic area is given as Re. When d>Re/100, the hydrophobic area 333 has a better self-alignment capability. Furthermore, the geometric center of the second hydrophilic area and the mass center of the micropart are preferably at the same point.

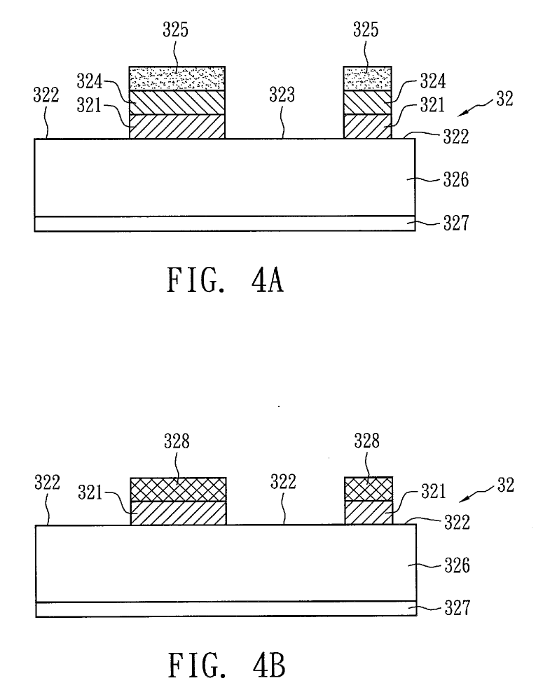

When the microparts are mounted on the substrate in water, another hydrophobic material can be coated on the hydrophobic area in order to improve the attraction of the hydrophobic areas of the microparts and the gold pads of the substrate. FIGS. 4A-4B are cross-sectional diagrams of the microparts in accordance with the present invention. These figures show the cross-sectional structure of the micropart 32 along the diagonal line of FIG. 3B. A self-assembly monomer layer 324 and adhesive 325 are sequentially coated on the surface of the hydrophobic area 321. The self-assembly monomer layer 324 can be hydrophobic alkanethiol, and adhesive 325 can be hydrocarbon glue. The hydrophobic area 321 is formed on a surface of the silicon substrate 326, and is the surface of the silica layer by oxidation treatment. A circuit layer 327 is on another surface opposite to the hydrophobic area 321. Furthermore, soldering 328 can be coated on the hydrophobic area 321, as shown in FIG. 4B.

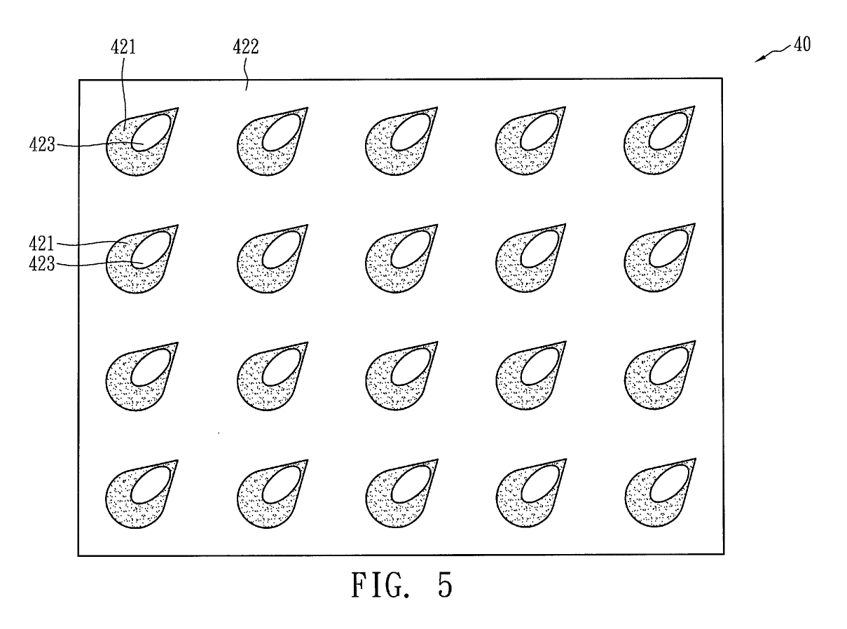

FIG. 5 is a top view of an apparatus for self-assembly and alignment of microparts in accordance with the present invention. The apparatus 40 for self-assembly and alignment of microparts can be a substrate with circuits whose material is metal, glass, composite material, ceramic material or semiconductor material. If the micropart 32 in FIG. 3B is selected for self-assembly and alignment, the apparatus 40 is equipped with hydrophobic areas 421 whose pattern is as the same as the pattern of the hydrophobic areas 321. The first hydrophilic area 422 surrounds the hydrophobic area 423, and the hydrophobic area 421 surrounds the second hydrophilic area 433.

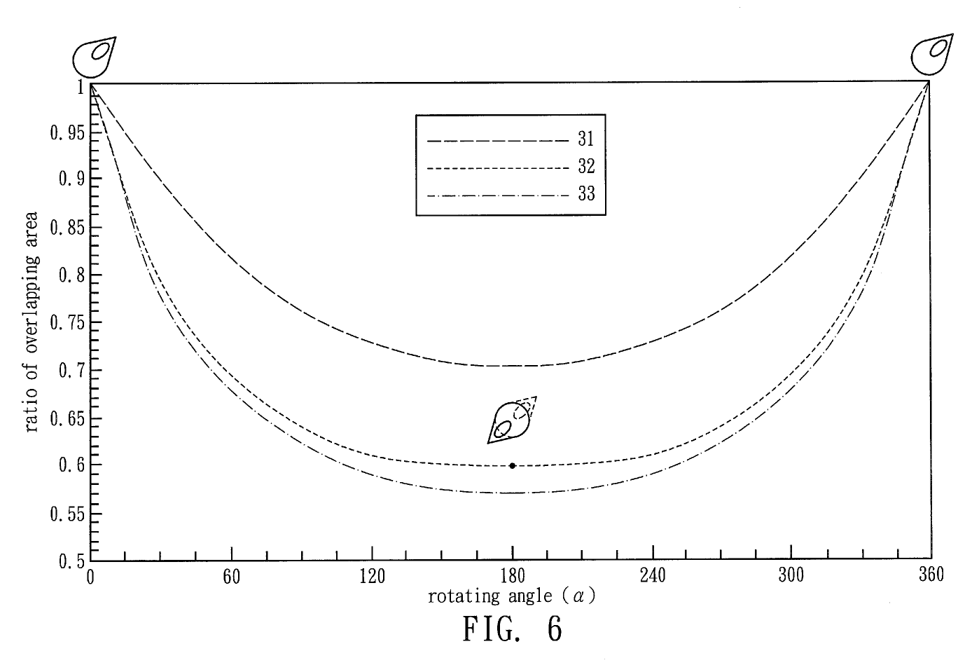

FIG. 6 shows a relation between the rotating angle and the overlapping area when all of the microparts in FIGS. 3A-3C and the hydrophobic region patterns on a substrate automatically align with each other. Apparently, each of the microparts 31-33 and the corresponding hydrophobic area on the substrate have only a relative angle so as to minimize the rate of overlapping areas between them. That is, only one maximum surface energy exists in a relative angle (180 degrees). Therefore, when each of the microparts is relative to a corresponding hydrophobic area on the substrate at any angle, the micropart can be drawn by capillarity force to rotate to a position without any relative angles, for example 0 degrees or 360 degrees.

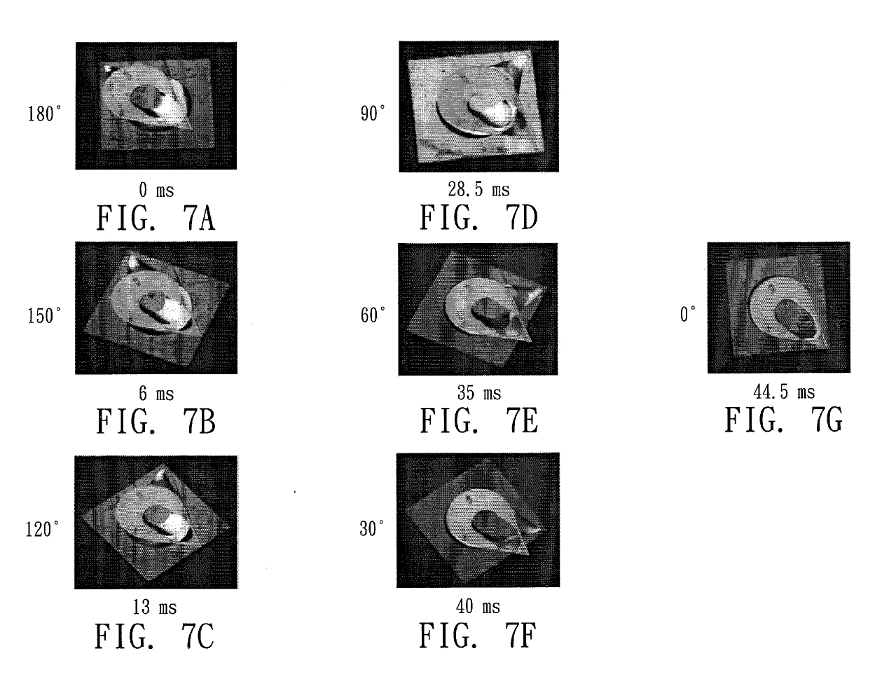

FIGS. 7A-7G are pictures of a micropart 33 and the hydrophobic region patterns on a substrate during the rotating motion of automatic alignment. FIG. 7A is a picture of the micropart 33 relative to the hydrophobic region patterns on a substrate in 180 degrees. Under the action of capillarity force, the micropart 33 rotates to a position where it completely overlaps the corresponding hydrophobic area on the substrate in 44.5 microseconds, as shown in FIG. 7G.

The above-described embodiments of the present invention are intended to be illustrative only. Those skilled in the art may devise numerous alternative embodiments without departing from the scope of the following claims.

What is claimed is:

1. A micropart, comprising:
a hydrophobic area;
a first hydrophilic area surrounding the hydrophobic area; and
a second hydrophilic area surrounded by the hydrophobic area.

2. The micropart of claim 1, wherein the hydrophobic area has a pattern with at most a symmetrical line.

3. The micropart of claim 2, wherein the pattern of the hydrophobic area is ring-shaped.

4. The micropart of claim 3, wherein the profile of the hydrophobic area is round or teardrop-shaped.

5. The micropart of claim 4, wherein the profile of the second hydrophilic area is an elliptical shape or a modified elliptical shape whose partial elliptical curves are replaced by arcs.

6. The micropart of claim 5, wherein the elliptical shape or the modified elliptical shape is near the border of the round hydrophobic area.

7. The micropart of claim 5, wherein the elliptical shape or the modified elliptical shape is near the tip of the teardrop-shaped hydrophobic area.

8. The micropart of claim 5, wherein the long axis of the elliptical or modified elliptical second hydrophilic area is overlapped with the symmetrical line of the hydrophobic area.

9. The micropart of claim 1, wherein the distance between the two geometric centers of the second hydrophilic area and the hydrophobic area is larger than one-hundredth of the effective diameter of the area of the second hydrophilic area.

10. The micropart of claim 1, wherein the first hydrophilic area and the second hydrophilic area are silica layers.

11. The micropart of claim 1, wherein the hydrophobic area is a gold layer.

12. The micropart of claim 1 1, wherein the surface of the gold layer is covered by a self-assembly monomer layer and adhesive, or by soldering.

13. The micropart of claim 1 1, wherein the hydrophobic area, the first hydrophilic area, and the second hydrophilic area are on a surface of the micropart opposite to another surface of the micropart on which circuits are disposed.

14. An apparatus for self-assembly and alignment of microparts, comprising:
a hydrophobic area;
a first hydrophilic area surrounding the hydrophobic area; and
a second hydrophilic area surrounded by the hydrophobic area.

15. The apparatus for self-assembly and alignment of microparts of claim 14, wherein the hydrophobic area has a pattern with at most a symmetrical line.

16. The apparatus for self-assembly and alignment of microparts of claim 14, wherein the pattern of the hydrophobic area is ring-shaped.

17. The apparatus for self-assembly and alignment of microparts of claim 16, wherein the profile of the hydrophobic area is round or teardrop-shaped.

18. The apparatus for self-assembly and alignment of microparts of claim 17, wherein the profile of the second hydrophilic area is an elliptical shape or a modified elliptical shape whose partial elliptical curves are replaced by arcs.

19. The apparatus for self-assembly and alignment of microparts of claim 18, wherein the elliptical shape or the modified elliptical shape is near the border of the round hydrophobic area.

20. The apparatus for self-assembly and alignment of microparts of claim 18, wherein the elliptical shape or the modified elliptical shape is near the tip of the teardrop-shaped hydrophobic area.

21. The apparatus for self-assembly and alignment of microparts of claim 18, wherein the long axis of the elliptical or modified elliptical second hydrophilic area is overlapped with the symmetrical line of the hydrophobic area.

22. The apparatus for self-assembly and alignment of microparts of claim 14, wherein the distance between the two geometric centers of the second hydrophilic area and the hydrophobic area is larger than one-hundredth of the effective diameter of the area of the second hydrophilic area.

23. The apparatus for self-assembly and alignment of microparts of claim 14, wherein the hydrophobic area is a gold layer.

24. The apparatus for self-assembly and alignment of microparts of claim 23, wherein the surface of the gold layer is covered by a self-assembly monomer layer and is attached by adhesive or by soldering.

25. The apparatus for self-assembly and alignment of microparts of claim 14, further comprising a substrate, wherein the first hydrophilic area and the second hydrophilic area are disposed on a surface of the substrate.

26. The apparatus for self-assembly and alignment of microparts of claim 25, wherein the material of the substrate is metal, glass, composite material, ceramic material or semiconductor material.
